(19) United States
(12) Patent Application Publication
(10) Pub. No.: US 2017/0012874 A1
(43) Pub. Date: Jan. 12, 2017

(54) SOFTWARE ROUTER AND METHODS FOR LOOKING UP ROUTING TABLE AND FOR UPDATING ROUTING ENTRY OF THE SOFTWARE ROUTER

(71) Applicant: Electronics and Telecommunications Research Institute, Daejeon-si (KR)

(72) Inventors: Hyun Yong LEE, Gwangju-si (KR); Bhum Cheol LEE, Daejeon-si (KR); Kang Il CHOI, Daejeon-si (KR)

(21) Appl. No.: 15/017,016

(22) Filed: Feb. 5, 2016

(30) Foreign Application Priority Data
Jul. 9, 2015 (KR) 10-2015-0097853

(51) Int. Cl. H04L 12/741

(52) U.S. Cl. CPC H04L 45/745

(57) ABSTRACT

A software router includes a main memory configured to comprise a hash table consisting of one or more buckets (hereinafter, referred to as “buckets A”) wherein each bucket stores destination information to which a unique key is mapped; and a central processing unit (CPU) configured to comprise a temporary table that stores the destination information present in the hash table, to determine a location of a bucket (hereinafter, referred to as “bucket B”) in the temporary table by applying a specific key to a designated hash function, wherein the specific key is extracted from a received packet, and to transmit the received packet by obtaining destination information from bucket B at the determined location in the temporary table.

### CROSS-REFERENCE TO RELATED APPLICATION(S)

This application claims priority from Korean Patent Application No. 10-2015-0097853, filed on Jul. 9, 2015, in the Korean Intellectual Property Office, the disclosure of which is incorporated herein by reference in its entirety.

### BACKGROUND

1. Field

The following description relates to a software router, and more particularly, to a data structure for representing a routing table and a method for looking up a routing table based on the data structure.

2. Description of Related Art

Based on the characteristics of a general-use central processing unit (CPU), a software router performs its functionality without the assistance of dedicated hardware, such as a ternary content addressable memory (TCAM) or an application specific integrated circuit (ASIC). The software router uses software for routing table lookup to determine to which network interface card (NIC)/port to transmit an incoming packet, and hence the way the routing table lookup is processed affects the performance of the software router.

In other words, a software router's performance is influenced by a layout of data structures used to represent a routing table, a location at which the routing table is stored, and the method and order in which routing table lookup is processed based on said data structures.

In earlier times, a software router would store a routing table in a main memory where the routing table would contain information as to which NIC (TxNIC) a specific packet is to be transmitted. But the packet processing performance of this earlier software router was poor, since the speed in which the main memory was accessed was slower than the CPU processing speed. Thus, a method of utilizing a CPU cache that has much a smaller capacity but is faster in terms of access speed, compared to the main memory, has been suggested so as to improve the packet processing performance.

One method of utilizing a CPU cache is to store the entire routing table in a CPU cache using a space-efficient and probabilistic data structure. Space-efficient and probabilistic data structures may cause errors to be presented in lookup results, no matter how infrequent said errors may occur. An example of such an error is that a Bloom filter may produce a result that indicates an entity is included in a particular element set when said entity is not.

As described above, there are a few drawbacks when space-efficient and probabilistic data structures are applied to a software router.

Above all, the number of data structures to be created increases depending on the number of TxNICs which, in turn, affects the software router performance in the following two aspects.

First, the space-efficient and probabilistic data structures may cause lookup errors, and hence all of the created data structures need to be searched in order to detect an error and find a TxNIC of a received packet. In the software router, the data structures need to be sequentially searched, and thus when the numbers of TxNICs and the data structures are increased, the time for routing-table lookup increases.

Second, due to the nature of space-efficient and probabilistic data structures, even though the total number of entities (e.g., the total number of routing table entries) may remain the same, the number of subsets (e.g., the number of tables divided from the routing table entries, or the number of TxNICs) would still affect the probability of errors. In other words, if the routing table entries were divided into more tables as the number of TxNICs is increased, the total probability of errors may also increase proportionally, which would mean that the number of accesses of what has been deemed a slow main memory increases, and hence the time required for routing table lookup would also increase.

Another problem that may arise when Bloom filters and modified Bloom filters are applied is that hash functions must be calculated multiple times (k>1), and memory must be accessed for the same number of times as said calculations despite the fact that only one Bloom filter is being looked up. This implies that quite a substantial amount of time would be required for processing even one Bloom filter.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a software router including: a main memory configured to comprise a hash table consisting of one or more buckets (hereinafter, referred to as “buckets A”) wherein each bucket stores destination information to which a unique key is mapped; and a central processing unit (CPU) configured to comprise a temporary table that stores the destination information present in the hash table, to determine a location of a bucket (hereinafter, referred to as “bucket B”) in the temporary table by applying a specific key to a designated hash function, wherein the specific key is extracted from a received packet, and to transmit the received packet by obtaining destination information from bucket B at the determined location in the temporary table.

In another general aspect, there is provided a method for looking up a routing table in a software router which comprises a main memory and a central processing unit (CPU), where the main memory comprises a hash table consisting of one or more buckets (hereinafter, referred to as “buckets A”) wherein each bucket stores destination information to which a unique key is mapped, and the CPU comprises a temporary table to store the destination information present in the hash table, the method including: determining a location of a bucket (hereinafter, referred to as “bucket B”) in the temporary table by applying a specific key to a designated hash function where the specific key is extracted from a received packet; and transmitting the received packet to a destination by obtaining destination information from bucket B at the determined location in the temporary table.

In yet another general aspect, there is provided a method for updating a routing entry in a software router which comprises a main memory and a central processing unit (CPU), where the main memory comprises a hash table consisting of one or more buckets (hereinafter, referred to as “buckets A”) wherein each bucket stores destination information to which a unique key is mapped, and the CPU comprises a temporary table to store the destination information present in the hash table, the method including: storing an additional routing entry in bucket A of the hash table, and storing the additional routing entry in a bucket (hereinafter, referred to as a “bucket B”) in the temporary table that is mapped with said bucket A; and deleting a specific routing entry from bucket A of the hash table and deleting destination information from said bucket B.

Other features and aspects will be apparent from the following detailed description, the drawings, and the claims.

### BRIEF DESCRIPTION OF THE DRAWINGS

FIG. 1 is a diagram illustrating a software router using a main memory.

FIG. 2A is a diagram illustrating a software router using a CPU cache.

FIG. 2B is a diagram illustrating a software router that stores a routing table in a CPU cache based on a Bloom filter.

FIG. 3 is a diagram illustrating a software router according to an exemplary embodiment.

FIG. 4 is a diagram illustrating a structure of a temporary table and a relationship between the temporary table and a hash table according to an exemplary embodiment.

FIGS. 5A to 5C are diagrams for explaining examples of management of a temporary table by a routing entry manager.

FIG. 6 is a flowchart illustrating a method for looking up a routing table according to an exemplary embodiment.

FIG. 7 is a flowchart illustrating a method for updating a temporary table when an entry is added to the routing table.

FIG. 8 is a flowchart illustrating a method for updating a temporary table when a routing entry is deleted.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

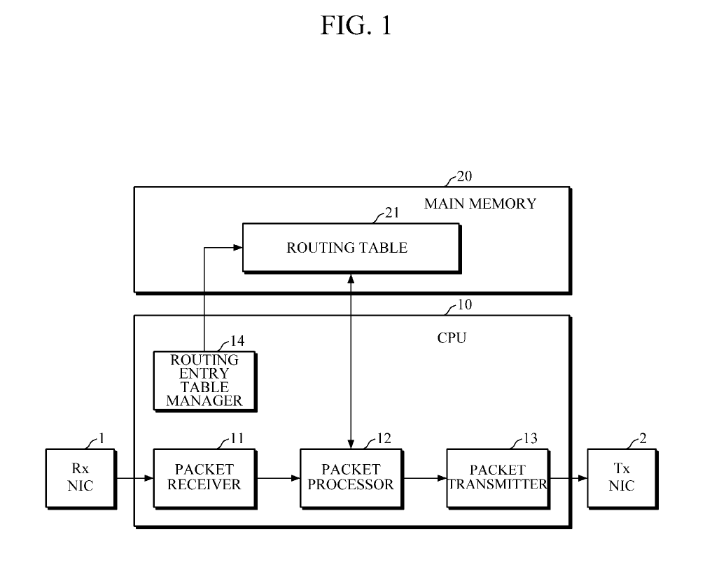

FIG. 1 is a diagram illustrating a software router using a main memory.

Referring to FIG. 1, an initial software router includes a central processing unit (CPU) 10 and a main memory 20, wherein the CPU 10 includes a packet receiver 11, a packet processor 12, a packet transmitter 13, and a routing entry manger 14 and the main memory 20 stores a routing table 21 that contains packet transmission information. Upon receiving a packet from a receive network interface card (RxNIC) 1 through the packet receiver 11, the packet processor 12 searches for a transmit NIC (TxNIC) address, which is a destination of the packet, from the rouging table 21 in the main memory 20, and transmits the received packet to a corresponding TxNIC 2 through the packet transmitter 13. Such a method for looking up the routing table 21 stored in the main memory 20, however, causes the packet processing performance degradation because a speed in which the main memory 20 is accessed is slower than a processing speed of the CPU 10.

Thus, in order to improve the packet processing performance, a method for utilizing a cache in the CPU 10 that has a smaller capacity, but is faster in terms of access speed, compared to the main memory 20, is proposed.

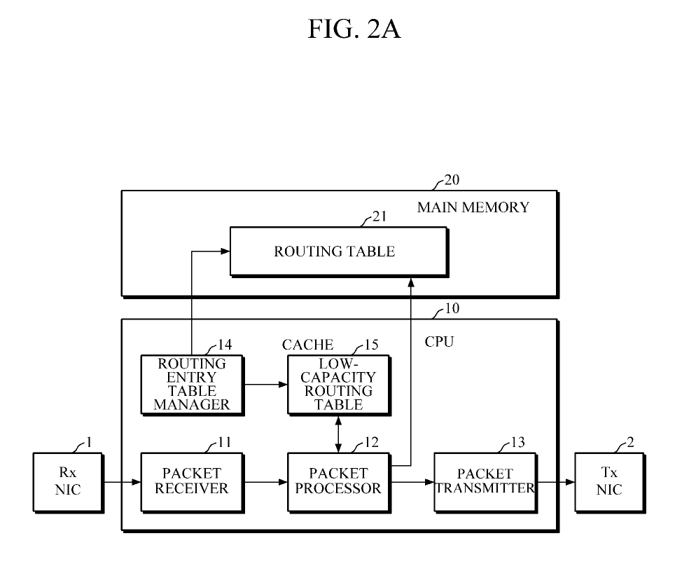

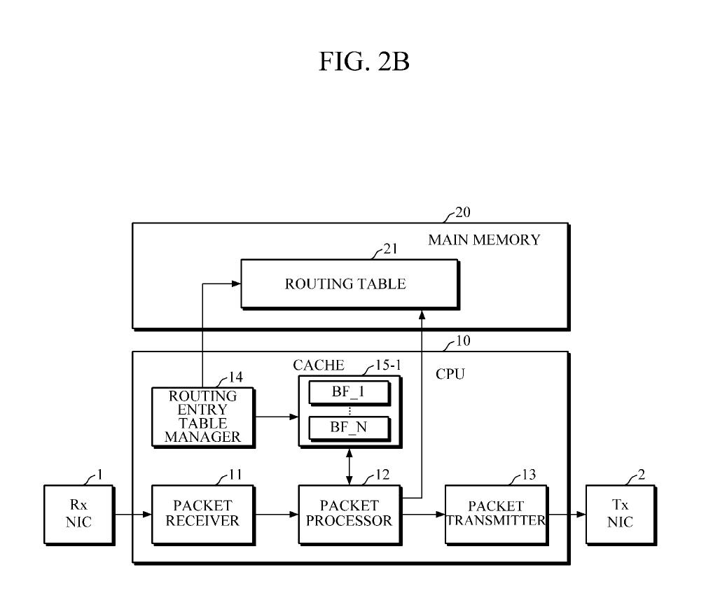

FIG. 2A is a diagram illustrating a software router using a CPU cache.

Referring to FIG. 2A, the whole or part of a routing table 21 present in the main memory 20 is stored in a CPU cache in the form of a low-capacity routing table 15, such that a packet is processed in the CPU 10 while access to the main memory 20 is avoided as much as possible. As one method for utilizing the CPU cache, the entire routing table is stored in the CPU cache using a space-efficient and probabilistic data structure. Such data structures may include Bloom filters, various modifications of Blood filters, and cuckoo filters.

Said data structures commonly support a membership query function, which determines as to whether a specific entity is included in a particular element set. In the case where aforesaid data structures are employed to represent a routing table in the CPU cache, routing table entries are divided into a number of tables based on the number of TxNICs to which the packet is transmitted, and one data structure is created for each table. That is, the resulting tables and the data structures are created as many as the TxNICs.

FIG. 2B is a diagram illustrating a software router that stores a routing table in a CPU cache based on Bloom filters.

Referring to FIG. 2B, BF_X 15-1 denotes Bloom filters that are generated for tables created in relation with TxNICs X. A packet processor 12 searches the Bloom filters in a CPU cache to identify in which table a received packet is included, i.e., to determine to which TxNIC said packet is transmitted. If failing to achieve accurate information due to false positives of the Bloom filters, the packet processor 12 looks up the routing table 21 in the main memory 20 and transmits the packet to TxNIC 2 which is found as a destination.

The space-efficient and probabilistic data structures, such as Bloom filters, may cause errors to be presented in the lookup results, no matter how infrequent said errors occur. For example, a Bloom filter may produce a result that indicates a specific entity is included in a particular element set when said entity is not. There are the following drawbacks when the space-efficient and probabilistic data structures are applied to a software router as described above.

A fundamental problem is that the number of data structures (e.g., the number of Bloom filters) to be created increases depending on the number of TxNICs, which affects a software router's performance in the following two aspects.

First, the space-efficient and probabilistic data structures may cause lookup errors, and hence all of the created data structures need to be searched in order to detect an error and find a TxNIC of a received packet. In the software router, the data structures need to be sequentially searched, and thus when the numbers of TxNICs and the data structures are increased, the time for routing-table lookup increases.

Second, due to the nature of space-efficient and probabilistic data structures, even though the total number of entities (e.g., the total number of routing table entries) may remain the same, the number of subsets (e.g., the number of tables divided from the routing table entries, or the number of TxNICs) would still affect the probability of errors. In other words, if the routing table entries were divided into more tables as the number of TxNICs is increased, the total probability of errors may also increase proportionally, which would mean that the number of accesses of what has been deemed a slow main memory increases, and hence the time required for routing table lookup would also increase.

Another problem that may arise when Bloom filters and modified Bloom filters are applied is that hash functions must be calculated multiple times (k>1) and memory must be accessed for the same number of times as said calculations despite the fact that only one Bloom filter is being searched for. This implies that quite a substantial amount of time is required for processing even one Bloom filter.

Therefore, the present disclosure proposes an apparatus and method for representing a routing table in a CPU cache using only one data structure in order to provide the same amount of time for routing table lookup, thus allowing for one hash function calculation within one time of memory access, regardless of the number of TxNICs, as compared to the aforesaid methods. Thus, it is possible to obtain information, required for packet transmission, within the same length of time by looking up only one data structure stored in the CPU cache, regardless of changes in the number of TxNICs. In specific, the present disclosure proposes a data structure (referred to as a “temporary table”) in a CPU cache for storing a routing table and a method for looking up the routing table based on the temporary table.

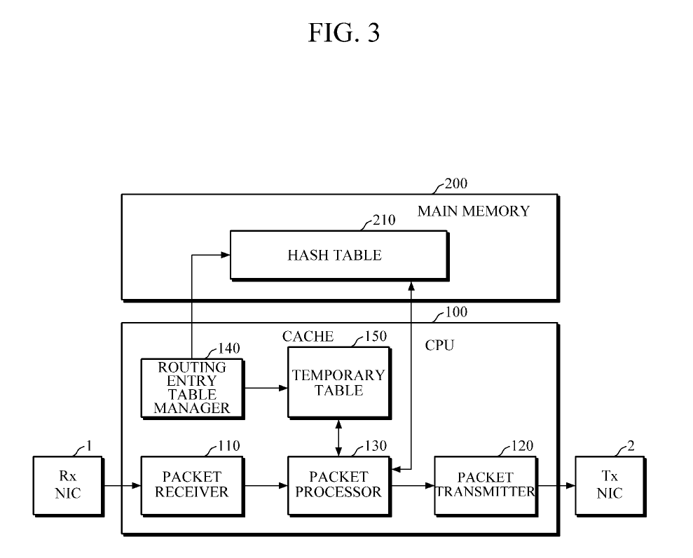

FIG. 3 is a diagram illustrating a software router according to an exemplary embodiment.

Referring to FIG. 3, the software router includes a CPU 100 and a main memory 200.

The main memory 200 includes a hash table 210 that consists of one or more buckets (hereinafter, referred to as “buckets A”), where each bucket stores destination information to which a unique key is mapped.

The CPU 100 includes a temporary table 150 that stores destination information present in the hash table 210. The CPU 100 extracts a specific key from a received packet, applies the specific key to a designated hash function to determine the location of a bucket (hereinafter, referred to as “buckets B”) in the temporary table 150, and transmits the received packet to a destination based on destination information obtained from bucket B at the determined location.

More specifically, the CPU 100 includes a packet receiver 110, a packet transmitter 120, a packet processor 130, a routing entry manager 140, and the temporary table 150.

The packet receiver 110 receives a packet from an RxNIC 1.

The packet processor 130 transmits the received packet to a destination after obtaining destination information. According to the exemplary embodiment, the packet processor 130 extracts the specific key from the received packet, assigns the specific key to a designated hash function to determine a location of bucket B in the temporary table 150, and obtains destination information from bucket B at the determined location. At this time, if failing to obtain the destination information from bucket B, the packet processor 130 accesses the hash table 210 to obtain the destination information. Since the temporary table 150 would cause errors to be presented in the lookup results, as the aforesaid space-efficient and probabilistic data structures do, the hash table 210 stored in the main memory 200 is searched in order to resolve such errors, despite the infrequent of said errors.

A method for transmitting a packet based on a temporary table may be applicable to an environment in which an NIC/port to which a given packet is to be transmitted is determined based on exact match in a temporary table stored in a high-speed memory, such as a CPU cache.

In one exemplary embodiment, in the case where the hash table 210 is a forwarding table, the packet processor 130 may search the temporary table 150 based on a MAC address of the received packet. In another exemplary embodiment, in the case where the hash table 210 is a MPLS forwarding table, the packet processor 130 may search the temporary table 150 based on a label of the received packet.

The routing entry manager 140 implements and manages a routing table within the main memory 200 based on the hash table 210. Also, the routing entry manager 140 generates and manages the temporary table 150 within the CPU 100 based on the hash table 210.

In this case, the temporary table 150 uses the same scheme as applied to the hash table, in order to provide the same amount of time for routing table lookup, regardless of changes in the number of TxNICs. In the hash table 210, in order to obtain a specific key, such as a value (e.g., NIC information) corresponding to an IP address, the specific key is hashed only once and access to bucket A at a location determined in the hash table 210 by said hashing is done only once. Accordingly, the temporary table 150 provides the same length of lookup time regardless of the number of TxNICs, i.e., enables routing table lookup through one hash function calculation within one memory access.

In addition, the temporary table 150 provides the same length of lookup time regardless of changes in the number of TxNICs, as well as represents the routing table in the CPU cache using the following method.

A general hash table stores key-value pairs to resolve hash collisions - two or more different entities are mapped to the same bucket. To this end, the hash table requires a memory of large capacity, so that it is impossible to store the hash table in a CPU cache which is considered as having a small capacity. Thus, the temporary table 150 only stores values of the hash table 210 in order to store the routing table in the small CPU cache while taking advantage of fast lookup speed of the hash table 210.

The temporary table 150 does not store keys used to resolve hash collisions and thus cannot directly solve such problems. In order to resolve hash collisions, the temporary table 150 assigns a collision flag to each of buckets B, where the collision flag represents a hash-collision state of a corresponding bucket A. Here, the collision flag may be one bit. A hash collision may be resolved by accessing the hash table 210 in the main memory 200.

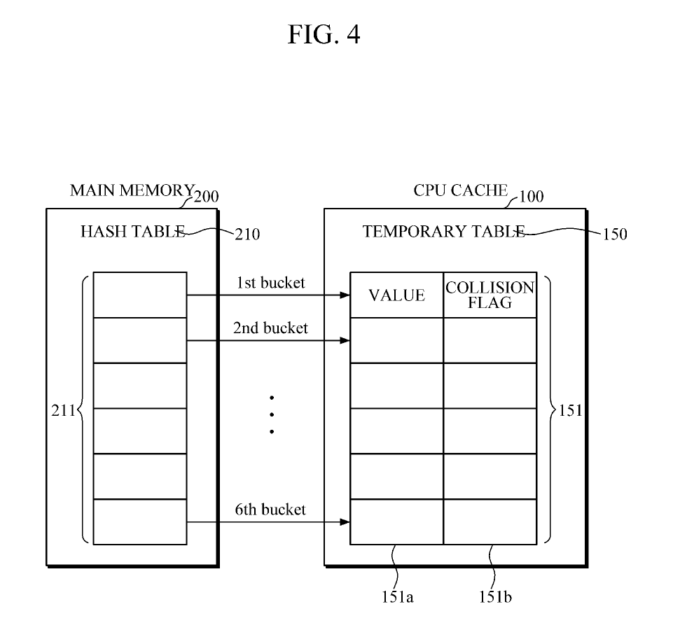

FIG. 4 is a diagram illustrating a structure of a temporary table and a relationship between the temporary table and a hash table according to an exemplary embodiment.

Referring to FIG. 4, the temporary table 150 consists of the same number of buckets B 151 as the number of buckets A 211 constituting the hash table 210, where each bucket B is mapped to each bucket A. Each bucket B 151 contains a value 151a and a collision flag 151b, where the value 151a stores destination information and the collision flag 151b represents whether a routing entry collision occurs in the mapped bucket A 211. Since the same number of buckets A and buckets B are provided and mapped to each other, management of both tables, such as continuous updates, can be easily done. For example, the x-th buckets of the temporary table 150 and the hash table 210 are mapped to each other, and both a value 151a and the content of a collision flag 151b in the x-th bucket B 151 of the temporary table 150 are determined by the content of the mapped x-th bucket A 211 in the hash table 210.

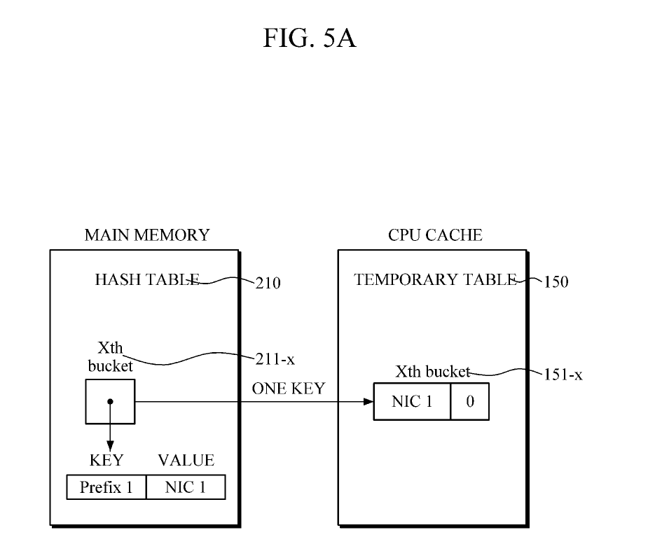

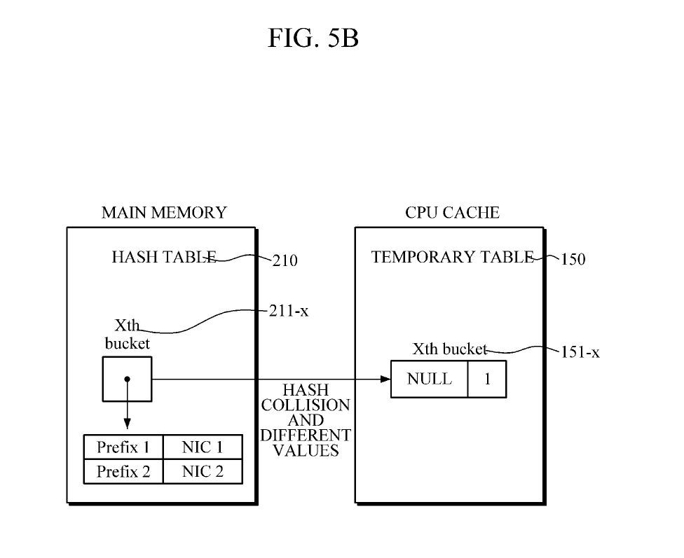

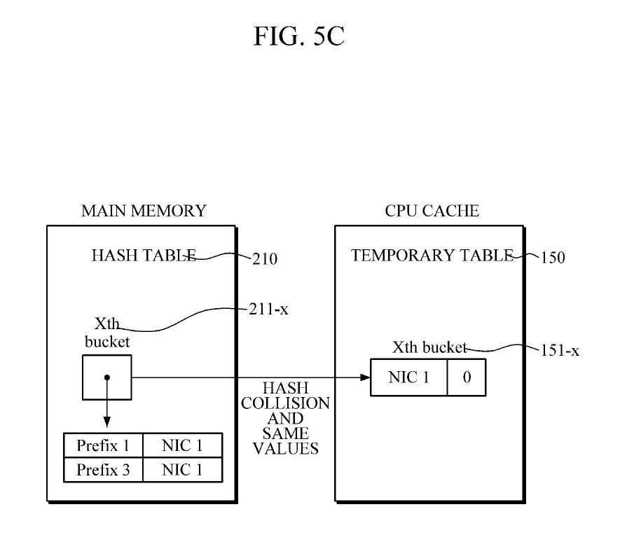

FIGS. 5A to 5C are diagrams for explaining examples of management of a temporary table by a routing entry manager.

In the case where bucket A contains one key and one piece of destination information, the routing entry manager 140 stores said destination information in bucket B mapped with said bucket A, and sets a collision flag to indicate no collision occurs. For example, referring to FIG. 5A, in the case where only one key is mapped to the x-th bucket A 211-x of the hash table 210, a value in the x-th bucket B 151-x of the temporary table 150 becomes “NIC 1” that is a value in bucket A 211-x of the hash table and a collision flag becomes “0” that represents no collision occurs.

In the case where bucket A contains two or more keys and two or more pieces of different destination information associated with the keys, the routing entry manager 140 does not store said destination information in bucket B mapped with said bucket A and sets a collision flag to indicate a collision occurs. For example, referring to FIG. 5B, if two or more keys are mapped to the x-th bucket A 211-x of the hash table 210 and values associated with the keys are different values “NIC 1” and “NIC 2”, a value in the x-th bucket B 151-x of the temporary table 150 is set as “NULL,” and a collision flag becomes “1” that represents the occurrence of a collision.

In the case where bucket A contains two or more keys and two or more pieces of the same destination information associated with said keys, the routing entry manager 140 stores the destination information in bucket B, mapped with said bucket A, and sets a collision flag to indicate no collision occurs. For example, referring to FIG. 5C, if two or more keys are mapped to the x-th bucket A 211-x of the hash table 210 and values corresponding to the keys are both “NIC 1,” a value in the x-th bucket B 151-k of the temporary table 150 is set as “NIC 1” and a value of a collision flag becomes “0” that represents no collision occurs.

Although the occurrence of a collision is represented by “0” and the occurrence of no collision is represented by “1” in FIGS. 5A and 5C, they may be represented the other way around.

Herein, a method for looking up a routing table in a software router and a method for updating a routing table will be described.

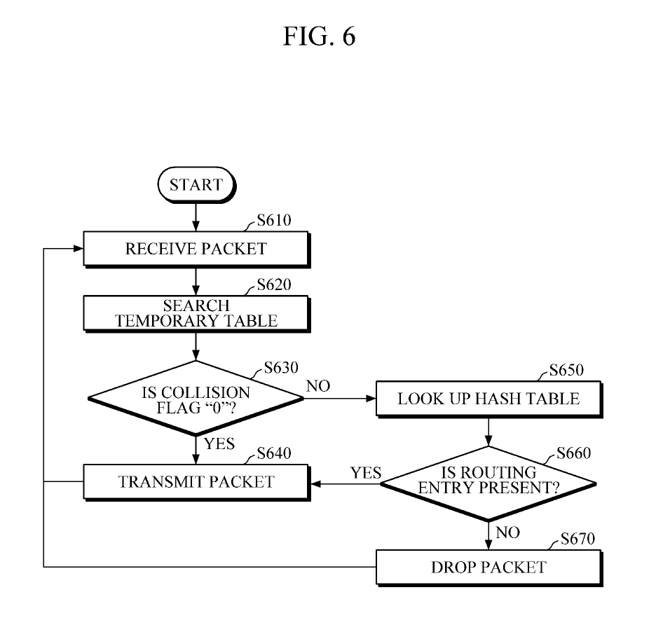

FIG. 6 is a flowchart illustrating a method for looking up a routing table according to an exemplary embodiment.

Referring to FIG. 6 and FIG. 3, when the packet receiver 110 of the software router receives a packet as depicted in S610, the packet processor 130 searches a temporary table to find information about a destination to which the received packet is to be transmitted, as depicted in S620. A location of bucket B in the temporary table 150 is determined by applying a hash function to a specific key extracted from the received packet, and a value and a collision flag are checked from the determined bucket B.

The packet processor 130 checks whether a collision flag is set as “0” as depicted in S630.

If it is determined in S630 that the collision flag is set as “0,” the packet processor 130 transmits the received packet to the TxNIC corresponding to the destination information obtained from bucket B, as depicted in S640.

On the contrary, if it is determined that the collision flag is “1,” then it indicates that bucket B does not contain necessary information, so the packet processor 130 looks up the hash table 210 stored in the main memory 200, as depicted in S650. That is, the packet processor 130 looks up bucket A of the hash table 210 that is mapped to bucket B of the temporary table 150.

The packet processor 130 checks whether a corresponding routing entry is present in the hash table 210 stored in the main memory 200, as depicted in S660.

If it is determined in 5660 that the routing entry is present in the hash table 210, i.e., that destination information for the received packet is present in the corresponding bucket B, the flow proceeds to operation 5640 in which the packet processor 130 transmits the packet to a Tx NIC that is represented by a value contained in bucket A of the hash table 210.

On the contrary, if it is determined that the routing entry is not present in the hash table 210, i.e., that the destination information for the packet is not present in bucket A, the packet processor 130 drops said packet, as depicted in S670.

The method for updating a routing table may include operations of adding a routing entry and deleting a routing entry. The routing table update method is performed by the routing entry manager 140 independently and separately from the routing table lookup method.

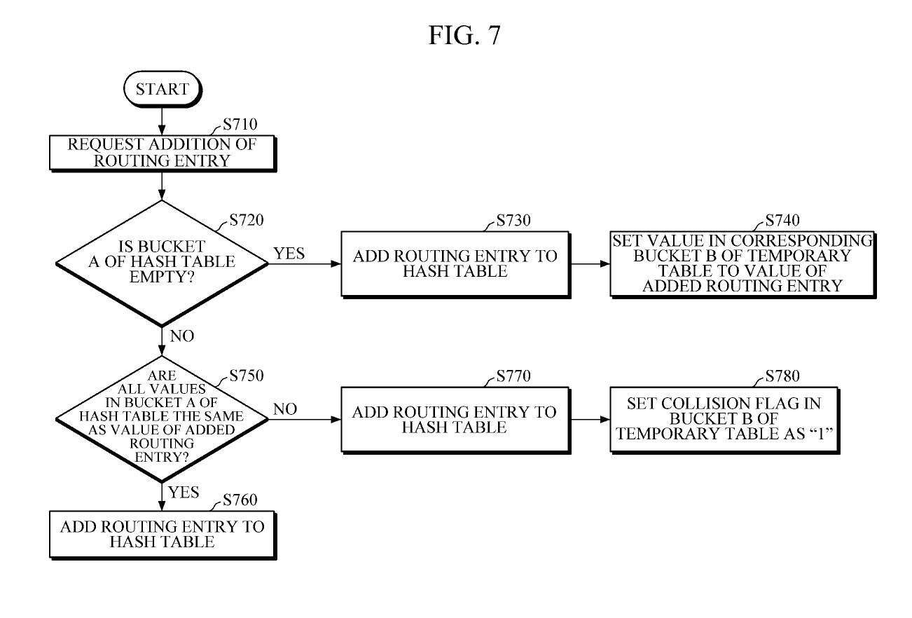

FIG. 7 is a flowchart illustrating a method for updating a temporary table when an entry added to the routing table.

Referring to FIG. 7 and FIG. 3, in response to a request for adding a routing entry, as depicted in S710, the routing entry manager 140 checks whether bucket A of the hash table 210 to which an added routing entry is mapped is empty, as depicted in S720.

If it is determined in S720 that bucket A of the hash table 210 is empty, the routing entry manager 140 adds the routing entry to said bucket A of the hash table 210, as depicted in S730, and sets a value in bucket B of the temporary table 150 that is mapped with said bucket A to a value of the added routing entry, as depicted in S740.

If it is determined in S720 that said bucket A of the hash table 210 is not empty, the routing entry manager 140 checks whether all values in said bucket A are the same as a value of the routing entry to be added, as depicted in S750.

If it is determined in S750 that the values are the same with each other, the routing entry manager 140 adds the routing entry only to the hash table 210, as depicted in S760. Because bucket B of the temporary table 150 has already contained the same value as the value of the routing entry to be added, no further update is required.

If it is determined in S750 that the values are not identical with each other, the routing entry manager 140 adds the routing entry to the hash table 210 as depicted in S770, as well as sets a value and a collision flag in bucket B of the temporary table 150 that is mapped with said bucket A to “NULL” and “1,” respectively, as depicted in S780.

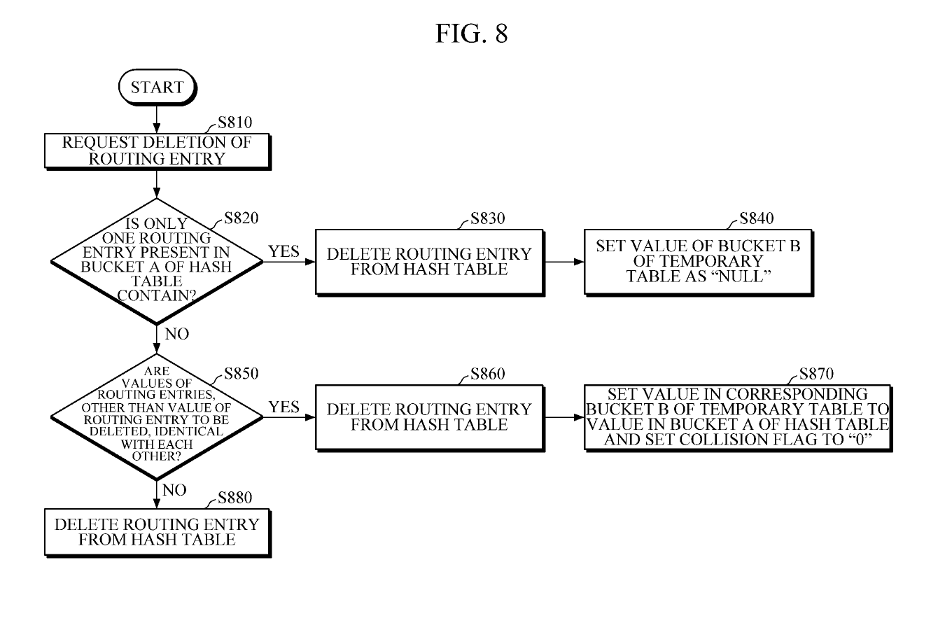

FIG. 8 is a flowchart illustrating a method for updating a temporary table when a routing entry is deleted.

Referring to FIG. 8, in response to a request for deleting a routing entry for bucket A, as depicted in S810, the routing entry manager 140 checks whether pertinent bucket A contains only one routing entry, as depicted in S820.

If it is determined in S820 that only one routing entry is present in bucket A, the routing entry manager 140 deletes the routing entry from the hash table 210, as depicted in S830, as well as sets a value in corresponding bucket B of the temporary table 150 to “NULL,” as depicted in S840.

On the contrary, if it is determined in S820 that two or more routing entries are present in said bucket A, the routing entry manager 140 checks whether values of the routing entries, other than a value of the routing entry to be deleted, are identical with each other, as depicted in S850.

If it is determined in S850 that the values, other than the value of the routing entry to be deleted, are identical with each other, the routing entry manager 140 deletes said routing entry from the hash table 210, as depicted in S860, sets a value in corresponding bucket B of the temporary table 150 to a value in said bucket A of the hash table 210, and sets a collision flag to “0” that represents no collision occurs, as depicted in S870.

If it is determined in S850 that the values of the routing entries, other than the value of the routing entry to be deleted, are not identical with each other, the routing entry manager 140 only deletes the routing entry from the hash table 210, as depicted in S880. In this case, the remaining keys still have different values from each other, and a collision flag in bucket B of the temporary table has been already set as “1,” and hence there is no need to change the content of said bucket B.

The temporary table-based software router according to the above exemplary embodiments has the following advantages, as compared to a software router based on space-efficient and probabilistic data structures, such as an existing Bloom filter.

First, a routing table is represented in a CPU cache using one data structure, and hence the same routing table lookup performance is provided, regardless of changes in the number of TxNICs.

Second, unlike the existing software router that uses Bloom filters and modified Bloom filters in which multiple hash calculations and multiple memory accesses are required, the software router according to the present disclosure can provide the same lookup functionality as provided by a hash table, thereby allowing for routing table lookup through only one hash calculation within only one memory access.

Third, in the case where routing table lookup is supported by parallel processing based on multiple CPU cores, i.e., where a single core is allocated to one or multiple data structures to implement the routing table lookup, the software router according to the present disclosure, for which the routing table is represented using one data structure, allows more benefits of parallelism, as compared to the existing software router that uses multiple data structures.

Fourth, if data structures, such as Bloom filters, are implemented using hardware, such as an application specific integrated circuit (ASIC), for the improvement of software router performance, the present disclosure that uses one data structure may be easier to implement, as compared to an existing software router that requires multiple data structures.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A software router comprising:
a main memory configured to comprise a hash table consisting of one or more buckets (hereinafter, referred to as “buckets A”) wherein each bucket stores destination information to which a unique key is mapped; and
a central processing unit (CPU) configured to comprise a temporary table that stores the destination information present in the hash table, to determine a location of a bucket (hereinafter, referred to as “bucket B”) in the temporary table by applying a specific key to a designated hash function, wherein the specific key is extracted from a received packet, and to transmit the received packet by obtaining destination information from bucket B at the determined location in the temporary table.

2. The software router of claim 1, wherein the temporary table consists of the same number of buckets B as a number of buckets A, where each bucket B is mapped to each bucket A, and each of buckets B contains the destination information and a collision flag that indicates whether a routing entry collision occurs in mapped bucket A.

3. The software router of claim 2, wherein the CPU comprises a packet receiver to receive a packet, a packet processor to achieve destination information for the received packet, a packet transmitter to transmit the packet to a destination based on the obtained destination information, and a routing entry manager to manage the temporary table based on the destination information present in the hash table.

4. The software router of claim 3, wherein in a case where bucket A contains one specific key and one piece of destination information associated with the key, the routing entry manager stores said destination information in bucket B, which is mapped with said bucket A, and sets the collision flag to indicate no collision occurs.

5. The software router of claim 3, wherein in a case where bucket A contains two or more keys and two or more pieces of different destination information associated with the keys, the routing entry manager does not store said destination information in bucket B, which is mapped with said bucket A, and sets the collision flag as a collision.

6. The software router of claim 3, wherein in a case where bucket A contains two or more keys and two or more pieces of identical destination information associated with the keys, the routing entry manager stores the destination information in bucket B, which is mapped with said bucket A, and sets the collision flag to indicate no collision occurs.

7. The software router of claim 3, wherein in response to a collision flag in bucket B at the determined location in the temporary table being set to indicate a collision occurs, the packet processor obtains destination information from the hash table.

8. The software router of claim 3, wherein in a case where the hash table is an Ethernet forwarding table, the packet processor searches the temporary table based on a media access control (MAC) address of the received packet.

9. The software router of claim 3, wherein in a case where the hash table is an MPLS forwarding table, the packet processor searches the temporary table based on a label of the received packet.

10. A method for looking up a routing table in a software router which comprises a main memory and a central processing unit (CPU), where the main memory comprises a hash table consisting of one or more buckets (hereinafter, referred to as “buckets A”) wherein each bucket stores destination information to which a unique key is mapped, and the CPU comprises a temporary table to store the destination information present in the hash table, the method comprising:
determining a location of a bucket (hereinafter, referred to as “bucket B”) in the temporary table by applying a specific key to a designated hash function where the specific key is extracted from a received packet; and
transmitting the received packet to a destination by obtaining destination information from bucket B at the determined location in the temporary table.

11. The method of claim 10, wherein the temporary table consists of the same number of buckets B as a number of buckets A, where each bucket B is mapped to each bucket A, and each of buckets B contains the destination information and a collision flag that indicates whether a routing entry collision occurs in mapped bucket A, and
wherein the method further comprises, in response to a collision flag in bucket B at the determined location in the temporary table being set to indicate a collision occurs, obtaining destination information from the hash table.

12. The method of claim 10, further comprising, in response to failing to obtain the destination information from the hash table, discarding the received packet.

13. A method for updating a routing entry in a software router which comprises a main memory and a central processing unit (CPU), where the main memory comprises a hash table consisting of one or more buckets (hereinafter, referred to as “buckets A”) wherein each bucket stores destination information to which a unique key is mapped, and the CPU comprises a temporary table to store the destination information present in the hash table, the method comprising:
storing an additional routing entry in bucket A of the hash table, and storing the additional routing entry in a bucket (hereinafter, referred to as a “bucket B”) in the temporary table that is mapped with said bucket A; and
deleting a specific routing entry from bucket A of the hash table and deleting destination information from said bucket B.

14. The method of claim 13, wherein the storing of the additional routing entry comprises, in a case where bucket A in which the additional routing entry is to be stored contains another routing entry and a value of the additional routing entry is identical with a value of the stored routing entry, storing the additional routing entry only in said bucket A.

15. The method of claim 13, wherein the storing of the additional routing entry comprises, in a case where bucket B in which the additional routing entry is to be stored contains another routing entry and a value of the additional routing entry is different from a value of the stored routing entry, storing the additional routing entry in said bucket A, as well as setting a collision flag of the temporary table to indicate a collision occurs.

16. The method of claim 13, wherein the deletion of the routing entry comprises in a case where values of routing entries, other than a value of the specific routing entry to be deleted, are identical with each other in bucket A, deleting the specific routing entry from said bucket A, setting a value in bucket B to the value of the identical routing entries of bucket A, as well as setting the collision flag to indicate no collision occurs.

17. The method of claim 13, wherein the deletion of the specific routing entry comprises, in a case where values of routing entries, other than a value of the specific routing entry, are different from each other in bucket A, deleting the specific routing entry from said bucket A of the hash table.
